(19) United States
(12) Patent Application Publication
(10) Pub. No.: US 2025/0091817 A1
(43) Pub. Date: Mar. 20, 2025

(54) SYSTEMS AND METHODS FOR PROVIDING OBJECT PROCESSING USING DISCHARGE ACTUATING CONTAINERS

(71) Applicant: Berkshire Grey Operating Company, Inc., Bedford, MA (US)

(72) Inventors: Jeffrey KITTREDGE, Lexington, MA (US); Abhishek KALURI, Beverly, MA (US); Mitchell GUILLAUME, Somerville, MA (US); Jennifer Eileen KING, Oakmont, PA (US); Kirsten WANG, Townsend, MA (US); Charles BAPTISTA, Arlington, MA (US); Kevin AHEARN, Nebo, NC (US)

(21) Appl. No.: 18/889,665

(22) Filed: Sep. 19, 2024

Related U.S. Application Data
(60) Provisional application No. 63/539,481, filed on Sep. 20, 2023.

(51) Int. Cl. B65G 47/38; B65G 13/00; B65G 19/02

(52) U.S. Cl. CPC B65G 47/38; B65G 13/00; B65G 19/02

(57) ABSTRACT

An object processing system is disclosed that includes a distribution system for distributing a plurality of objects among a plurality of containers, an output conveyance system for receiving a plurality of completed containers, and a container discharge system for emptying any contents of a container of the plurality of completed containers into a destination location, the container discharge system including a discharge conveyor section in which the container is suspended and moved in a conveyor direction while permitting a bottom of the container to drop open to discharge any contents of the container into the destination location.

### PRIORITY

The present application claims priority to U.S. Provisional Patent Application 63/539,481, filed Sep. 20, 2023, the disclosure of which is hereby incorporated by reference in its entirety.

### BACKGROUND

The present invention relates to unit sortation systems and other object processing systems for objects such as items, products, packages and other stock keeping unit (SKU) pieces as well as totes, bins and boxes containing such items, products, packages and SKUs. The present invention relates in particular to unit sortation systems that sort to a large number of containers such as bins, totes, boxes, etc.

Many conventional unit sortation systems are used for example, in package sortation and in e-commerce order fulfillment. In the case of package sortation, the unit sorter will sort packages coming into a facility from a range of locations and sort them into groupings of next station or hub or trailer truck or zip code, etc. In the case of e-commerce order fulfillment, the unit sorter will sort a mix of SKUs into individual customer orders or groups of customer orders. For example, there may be work savings in creating heterogeneous mixes of SKUs from homogenous input sources such as totes or shelves.

A unit sorter system may for example receives an item on a tray or bomb bay carrier, etc., and then it circulates the item with many other carriers carrying other items at the same time. When the carrier arrives at the destination for which the item is destined, the carrier actuates in some way. If it is a tilt tray, it tilts to empty its payload. If it is a bomb bay, the bomb bay doors open to release the item. If it is a cross-belt, the belt actuates to convey the payload off the carrier and so on. In this way sometimes over 10,000 units can be delivered to 100s of sorter destinations per hour.

The long perimeter of the unit sorter is good for the economics of the unit sorter. In the applications for the unit sorter such as package sortation and e-commerce order fulfillment, there are efficiency benefits to greater numbers of sort destinations. There is a large initial cost for the unit sorter and a small marginal cost to adding more destinations. As a result, many unit sorters have hundreds of destinations because efficiency increases.

The greater the number of destinations however, the greater the perimeter. This long perimeter spreads out the work that people need to do to process the items that go to the sort destinations. Workers who process the items that have been sorted have to walk between the many chutes or sort destinations. The workers must visit every single of the hundreds of destinations and empty the chute or tote or bag that receives the items.

There remains a need therefore, for more capable, efficient and economical unit sorter systems and other object processing systems that require sorting a large number of items to a large number of processing locations. There is further a need to reduce time expended by human personnel in waiting, walking and decision making in facilitating the operation of the system.

### SUMMARY

In accordance with an aspect, the invention provides an object processing system that includes a distribution system for distributing a plurality of objects among a plurality of containers, an output conveyance system for receiving a plurality of completed containers, and a container discharge system for emptying any contents of a container of the plurality of completed containers into a destination location, the container discharge system including a discharge conveyor section in which the container is suspended and moved in a conveyor direction while permitting a bottom of the container to drop open to discharge any contents of the container into the destination location.

In accordance with another aspect, the invention provides an object processing system that includes a distribution system for distributing a plurality of objects among a plurality of containers, an output conveyance system for receiving a plurality of completed containers, each of said completed containers being provided on the output conveyance system but not being fixedly attached to the output conveyance system, and a container discharge system for emptying any contents of a container of the plurality of completed containers into a destination location, the container discharge system including a discharge conveyor section in which the container may drop open to discharge any contents of the container into the destination location.

In accordance with a further aspect, the invention provides a method of processing objects that includes receiving a plurality of completed containers, and emptying any contents of a container of the plurality of completed containers into a destination location by moving the container along a discharge conveyor section in which the container is suspended and moved in a conveyor direction while permitting a bottom of the container to drop open to discharge any contents of the container into the destination location.

### BRIEF DESCRIPTION OF THE DRAWINGS

The following description may be further understood with reference to the accompanying drawings in which:

FIG. 1 shows an illustrative diagrammatic plan view of an object processing system in accordance with an aspect of the present invention;

FIG. 2 shows an illustrative diagrammatic elevated side view of the system of FIG. 1;

FIG. 3 shows an illustrative diagrammatic view of a servicing area of the system of FIG. 1;

FIGS. 4A and 4B show illustrative diagrammatic views of a completed bin being removed by a transfer unit, showing the completed bin being elevated (FIG. 4A) and urged onto a replenishment/takeaway conveyor (FIG. 4B);

FIGS. 5A and 5B show illustrative diagrammatic views of an empty container being provided to the servicing area, showing the empty container approaching (FIG. 5A) and showing the empty container being urged to a loading position (FIG. 5B);

FIGS. 6A and 6B show illustrative diagrammatic exploded views of a transfer unit in accordance with an aspect of the present invention, showing a side view (FIG. 6A) and showing an end view (FIG. 6B);

FIGS. 7A and 7B show illustrative diagrammatic side views of the transfer unit of FIGS. 6A and 6B showing the payload receiving portion not elevated with respect to the base (FIG. 7A) and showing the payload receiving portion elevated with respect to the base (FIG. 7B);

FIG. 8 shows an illustrative diagrammatic function view of a container and bag fullness evaluation system in accordance with aspect of the present invention;

FIG. 9 show an illustrative diagrammatic side view of a container used in the system of FIG. 1;

FIGS. 10A-10C show illustrative diagrammatic side views of the container of FIG. 9 approaching a discharge station (FIG. 10A), discharging contents of the container (FIG. 10B), and leaving the discharge station (FIG. 10C);

FIGS. 11A and 11B show illustrative diagrammatic end views of the container approaching the discharge station (FIG. 11A) and discharging contents of the container (FIG. 11B);

FIGS. 12A and 12B show illustrative diagrammatic underside views of the container approaching a discharge area that is not scheduled for discharge (FIG. 12A) and showing an override bar engaged to prevent the discharge of objects within the container (FIG. 12B);

FIG. 13 shows an illustrative diagrammatic elevated end view of the container of FIG. 9 showing the hinge assemblies of the container;

FIG. 14 shows an illustrative diagrammatic view of a portion of a container being checked for proper orientation;

FIG. 15 shows an illustrative diagrammatic end elevational view of the container of FIG. 9 showing a closed-detection system; and

FIG. 16 shows an illustrative diagrammatic underside view of a discharge area showing a destination container completeness perception system.

The drawings are shown for illustrative purposes only.

### DETAILED DESCRIPTION

The invention in accordance with an aspect provides a system for reducing the manual work needed to service unit sorters and to centralize processing of objects such as items, packages, SKUs containers, products, etc., sorted by unit sorters. The system including automated mechatronic components may provide the following. The system may put empty containers at or underneath each chute or sort destination, may take away full containers at or underneath each chute or sort destination, may bring the containers to centralized processing stations for loading or packing into other containers, further sorting, or other processing, and may optionally automate removal of objects from specially designed containers. As used herein, containers include at least totes, bins and boxes. Applications of systems in accordance with certain aspects of the invention may include package sortation facilities that use unit sorters, e-commerce order fulfillment centers that sort batch pick orders with unit sorters, and any other systems that employ unit sorters.

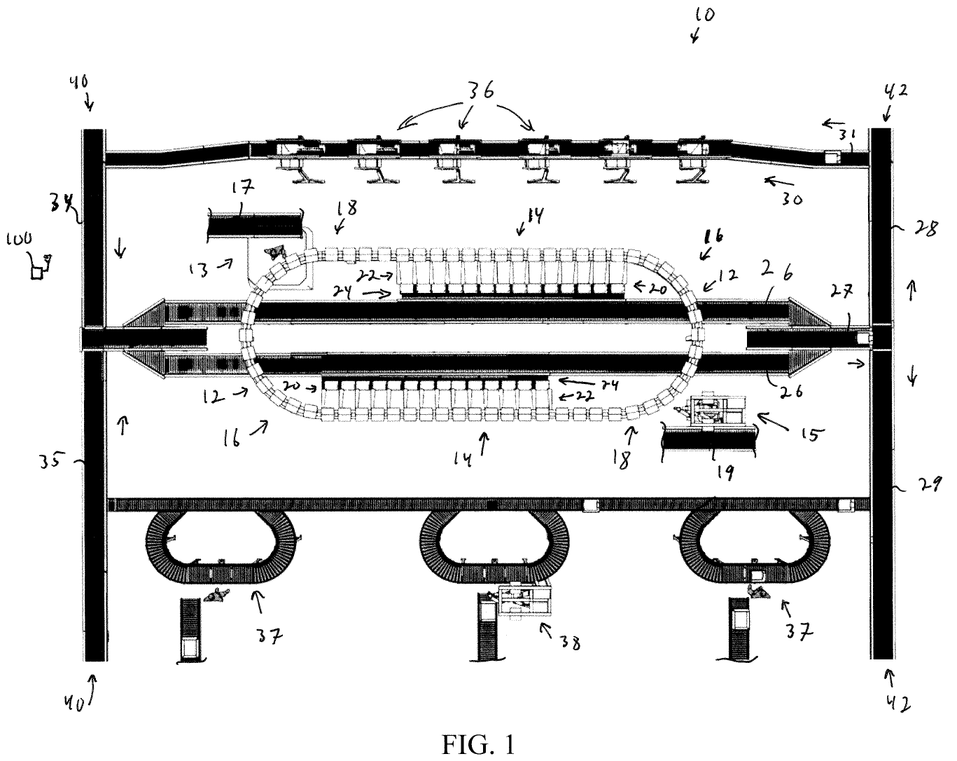

FIG. 1 shows a top view of a unit sortation system 10 in accordance with a representative aspect of the present invention that includes a loop conveyance system 12 that includes two straight sections 14 and two curved sections 16. The straight sections 14 each include input areas 18 at which objects such as packages, products, items, etc., may be placed onto empty carriers of the loop conveyance system 12, for example by human personnel (as shown at 13) or by using a programmable motion device (as shown at 15). Each input area may include an input conveyor (17, 19) for bringing the objects to be processed. Only a portion of each conveyor (17, 19) is shown for clarity. The loop conveyance system may include carriers of any of tilt trays, bomb-bay units, cross-belt conveyors, etc., that travel around the loop in a continuous fashion. The object is scanned prior to induction, or by a scanning system at some point along the loop. The straight sections 14 also include receiving containers 20, optionally via chutes 22 on each of the sections 14. The containers may be provided on shelves or conveyors 24 as discussed further herein. This scanned barcode determines to which chute the object should be ejected from the carrier. The object rides along on the carrier until it arrives at chute, then the unit sorter ejects via various mechanisms such a bomb-bay, tilt tray, cross-belt, etc. The receiving containers 20 (and chutes 22) may be provided on one or both sides (e.g., inside and outside) of the loop 12. The containers 20 when completed may be processed automatically using takeaway and replenishment systems that process containers on one side thereof or that process containers on both sides thereof in accordance with certain aspects of the present invention. In accordance with various aspects the takeaway and replenishment systems may include a variety of components and functionalities as discussed herein that provide container takeaway and container replenishment along a variety of directions to and from the systems. With reference to FIG. 1 again, the system 10 includes for example, two replenishment/takeaway conveyors 26 that lead via outfeed conveyor 27 to output path conveyors 28, 29 that access either container emptying stations 30 (such as bagging stations) via entrance conveyor 31 or workstations 32 that may be manual (as shown at 37) or automated (as shown at 38) at which, for example, boxes are packed. New empty containers may be added to the system as needed at entrances 40 of a return-path conveyors 34, 35, and any containers to be removed from the system may be removed at container exits 42 at the ends of the output path conveyors 28, 29.

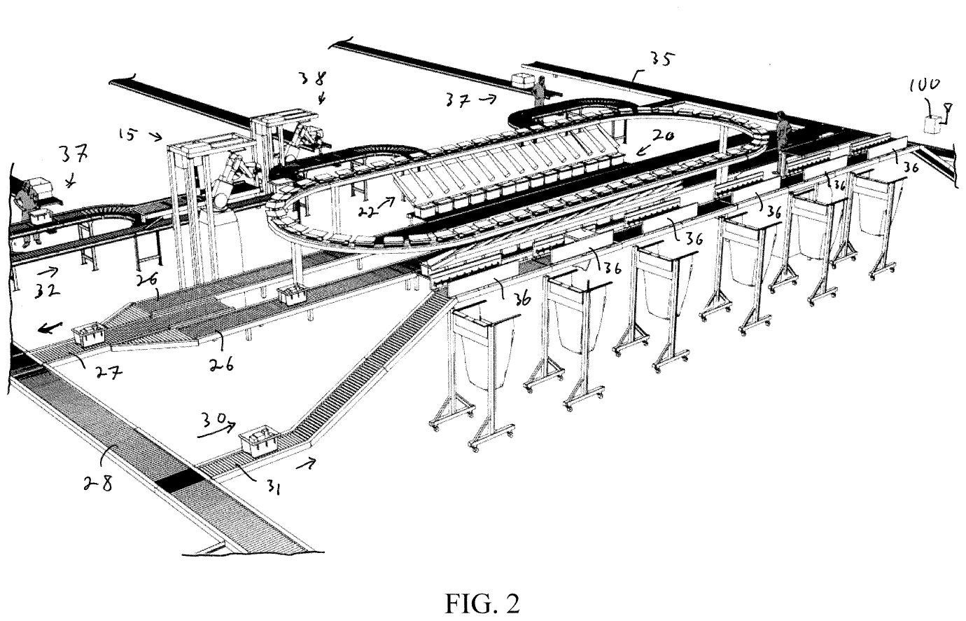

FIG. 2 shows an elevated end view of the system 10 showing that the chutes 22 receive objects from the loop conveyance system 12 that includes, for example, tilt trays. The chutes 22 lead to containers (e.g., totes, bins, boxes, etc.), and the containers may be provided on any of static shelves, static conveyors or movable conveyors 24 (as shown in FIG. 1). Each object that is placed onto the loop conveyance system 12 is assigned a particular container, and the system drops the object into the associated chute when the object is above the associated chute while moving along the loop conveyance system. The conveyors 26 lead to the output path conveyors 28, 29 from which containers may be directed to either the container emptying stations as shown at 30 or to the workstations as shown at 32 (again either manual or automated).

Operation of the system including the conveyors, tilt trays, and perception systems and automated processing systems is provided by one or more computer processing systems 100. The one or more computer processing systems 100 coordinate the movements of the conveyor and automated mobile transfer unit(s) and keeps track of the states and identities of all containers on shelves and conveyors. For example, as the transfer unit is passing a full container from shelf to conveyor, it may pause the advance of preceding containers so that the full container has an empty zone on the conveyor to occupy as it is transferred by the servicing transfer unit to the conveyor. Where the conveyor is a zero-accumulation conveyor, there are options for the spacing of perception unit (such as photo-eyes) on the conveyor. The empty containers may be provided as needed. For the transfer unit to transfer onto the conveyor the whole zone on the receiving conveyor or shelf mush be empty. For the transfer unit to transfer off of the conveyor, the desired container must be positioned in front of the zone. In all cases there may be only one container per zone. Note that there needs to be population of empty containers continually in circulation on the conveyors. Generally, the rate of replenishing containers should match the rate at which containers get kicked out.

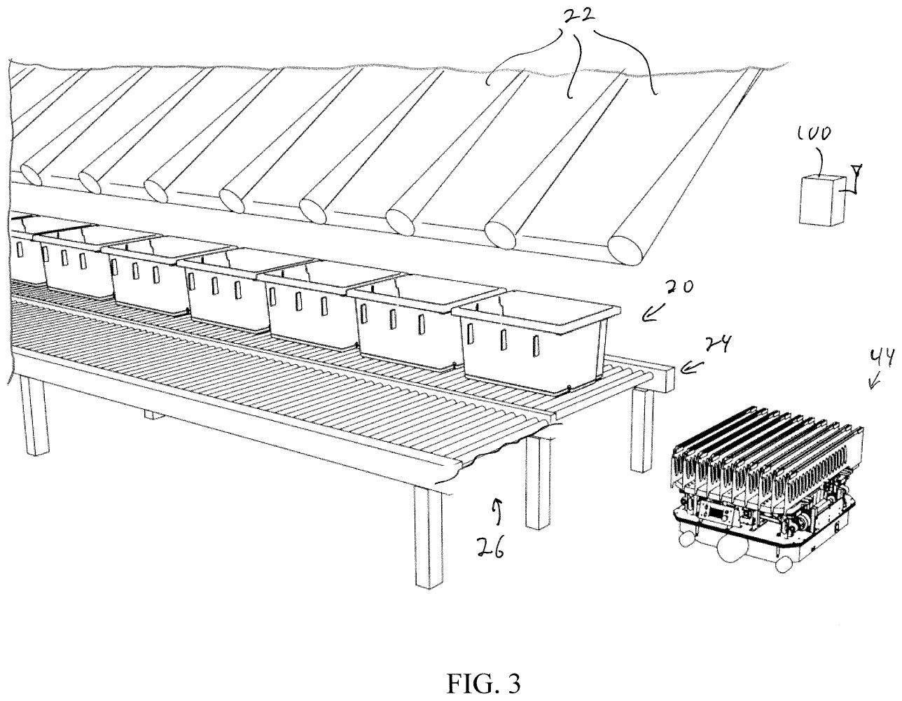

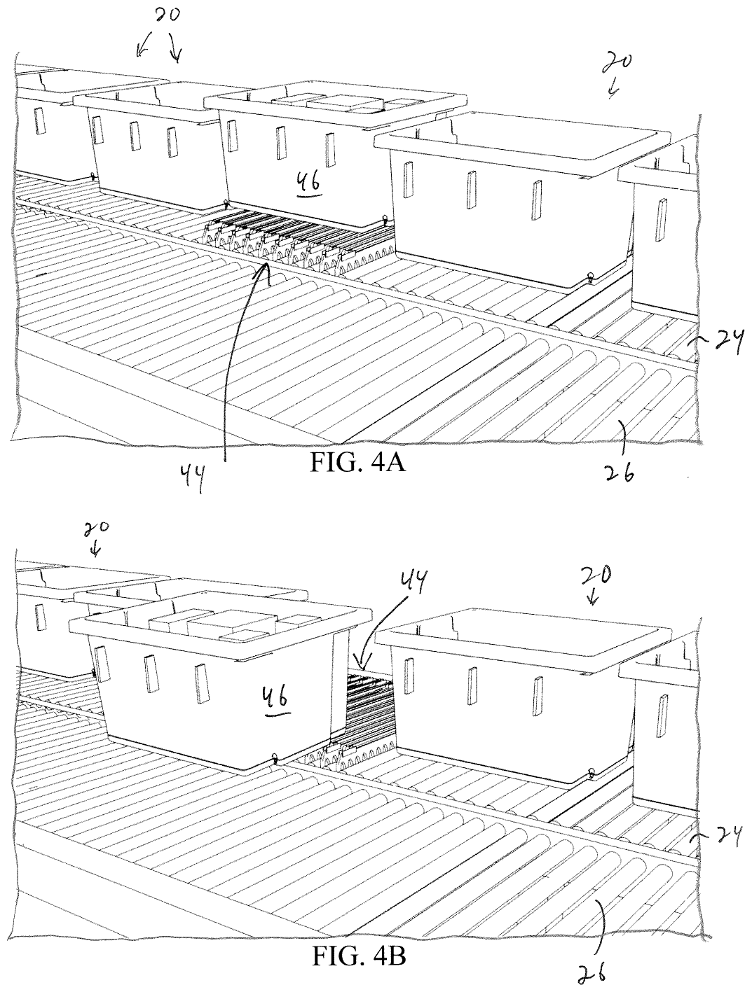

In accordance with certain aspects, a transfer unit may be used that provides a cross-direction transfer mechanism on the transfer unit itself. FIG. 3, for example shows a takeaway and replenishment system that includes chutes 22 leading to containers 20 on a static shelf 24 as well as an adjacent replenishment and takeaway conveyor 26. Automated mobile transfer units 44 move (e.g., reciprocally) along an aisle under the shelf 24 and are employed to move completed containers onto the conveyor 26. As discussed in more detail below, each transfer unit 44 includes elevatable blades that extend up between tines (or static rollers) of the slotted shelf 24 to lift a completed container (e.g., 46 as shown in FIG. 4A), and narrow belted conveyors on the top of each blade that transfer the completed container 46 from the shelf 24 to the conveyor 26 (as shown in FIG. 4B).

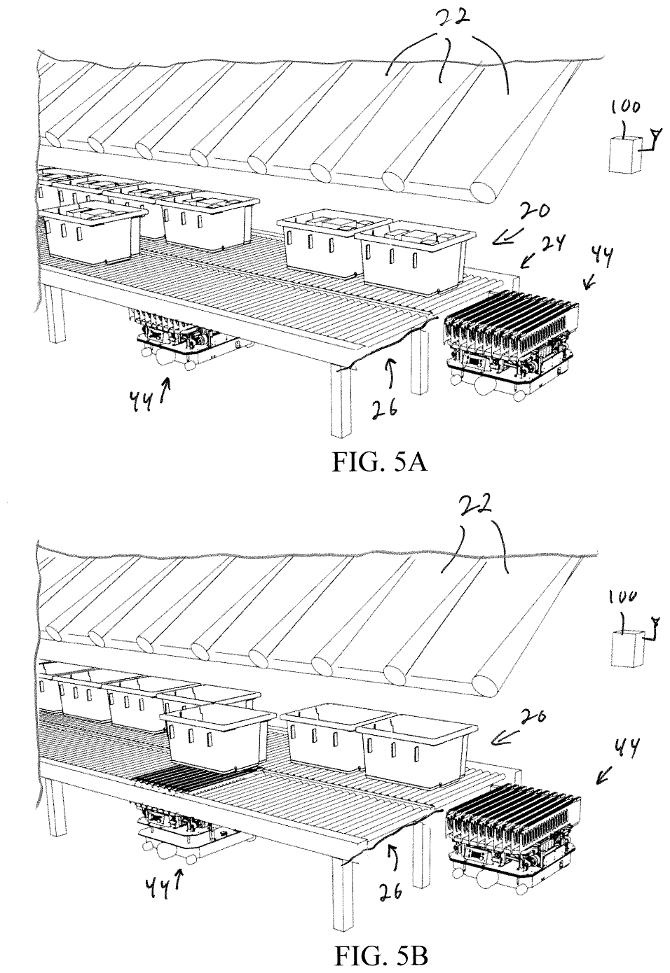

With reference again to FIG. 4A, the completed container 46 is selected from among the plurality of containers on the shelf 24 and is transferred to the conveyor 26 by the narrow-belted conveyors on the elevated blades of the transfer unit 44. With reference to FIG. 5A the conveyor 26 may be actively moving (and as further discussed herein its movement may be intermittently controlled) to move the completed container 46 toward an output end of the conveyor 26. The system may either replace a new empty container into the location on the shelf 24 remaining following removal of the container 46 or the shelf 24 may be provided as a roller conveyor in which the rollers may be individually (or by section such as a section associated with an individual container) actuatable (powered or by gravity) to move containers formerly adjacent the removed container in a direction to fill the void left by the removed container. Empty containers may then be replenished (e.g., by human personnel or automated system) at the end of the shelf in the direction from which the moved containers had moved. In accordance with various aspects, the containers may be moved until touching each other where the distal end of the line of containers is maintained at a fixed location. Conversely, perception systems may be employed together with separately actuatable rollers to position containers at specific known locations. The perception system may include any of photo-detectors, cameras, 2D scanners and 3D scanners mounted on or near the shelf, as well as weight sensing conveyor roller mounts, and wireless position tracking systems such as Bluetooth, echo-location and GPS systems.

In accordance with certain aspects the empty location that remains after the completed container 46 is removed may be individually filled using, for example, a further automated mobile transfer unit 44 that moves (e.g., reciprocally) under the conveyor 26 as shown in FIGS. 5A and 5B. FIG. 5A shows an empty container 48 being moved along the conveyor 26, and FIG. 5B shows the unit 44 being activated as discussed herein to transfer the empty container 48 from the conveyor 26 to the shelf 24. Any of the automated mobile transfer units 44 disclosed herein may also be moved in directions other than the associated reciprocating directions by activating the primary central drive wheels differently (e.g., in speed or opposing directions) to provide that a single transfer unit may be moved from under one of a shelf or conveyor to the other of the shelf or conveyor (thus avoiding using two transfer units). Such two-dimensional movement of the transfer units however, requires further safeguards regarding the precise positioning of each transfer unit under a shelf or conveyor to ensure that the blades precisely rise between upper rollers, tines, slots, etc.

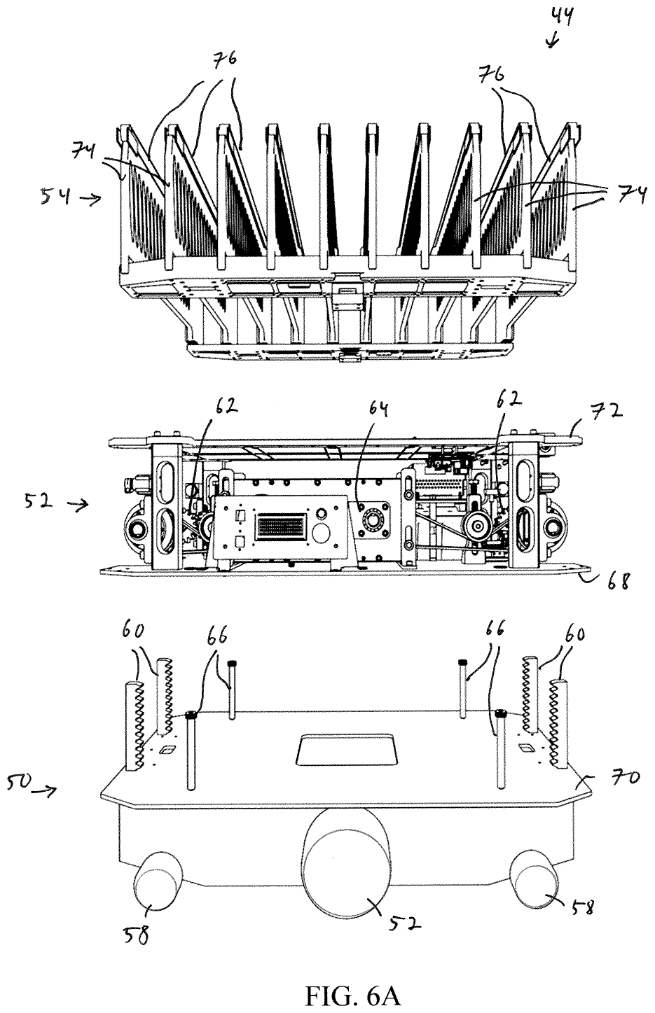

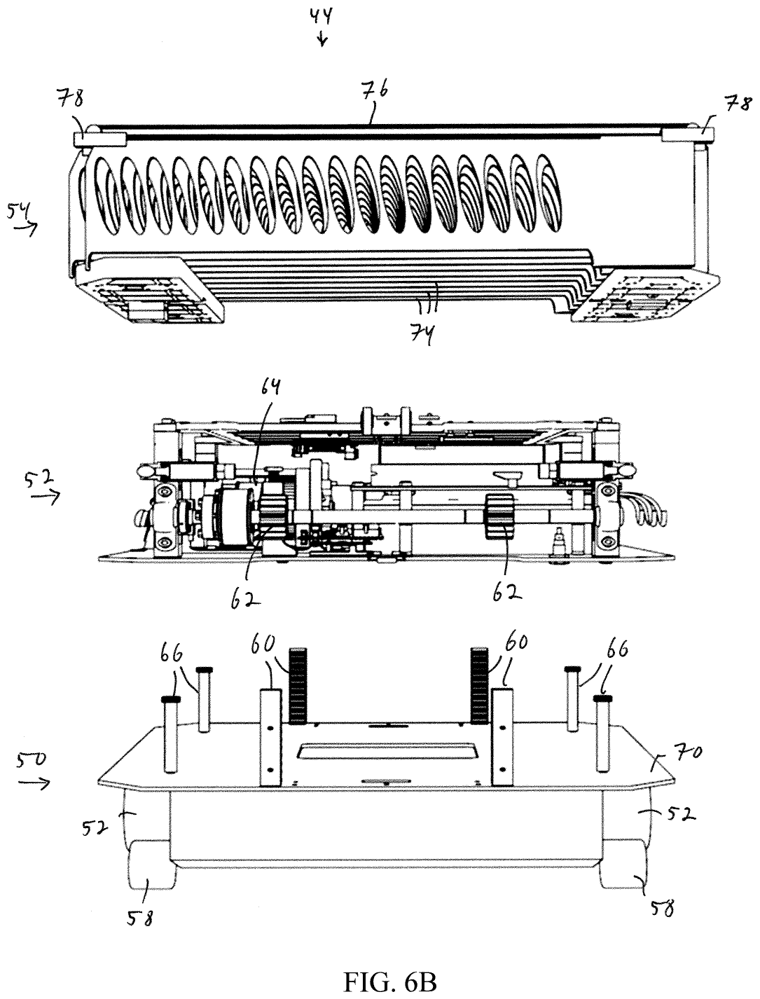

FIG. 6A shows an exploded side view of the transfer unit 44 and FIG. 6B shows an exploded end view of the transfer unit 44. The transfer unit 44 includes a unit base 50, a support structure 52, and a payload receiving portion 54. The unit base 50 includes a pair of central drive wheels 56 as well as two sets of leveling wheels 58. The unit base 50 also includes two pairs of gear racks 60 that engage with pinion gears 62 on the support structure 52. The support structure 52 includes a drive system 64 that powers the pinion gears 62 to rotate on their respective axles, and rotation of the pinion gears 62 causes the support structure 52 to rise with respect to the unit base 50. The unit base 50 also includes capped slide rods 66 that limit vertical movement of the support structure 52 away from the unit base 50, and in particular limit movement of the floor 68 of the support structure 52 away from the top surface 70 of the unit base 50. Reversing the rotation of the pinion gears 62 by the drive system 64 brings the support structure down toward the unit base.

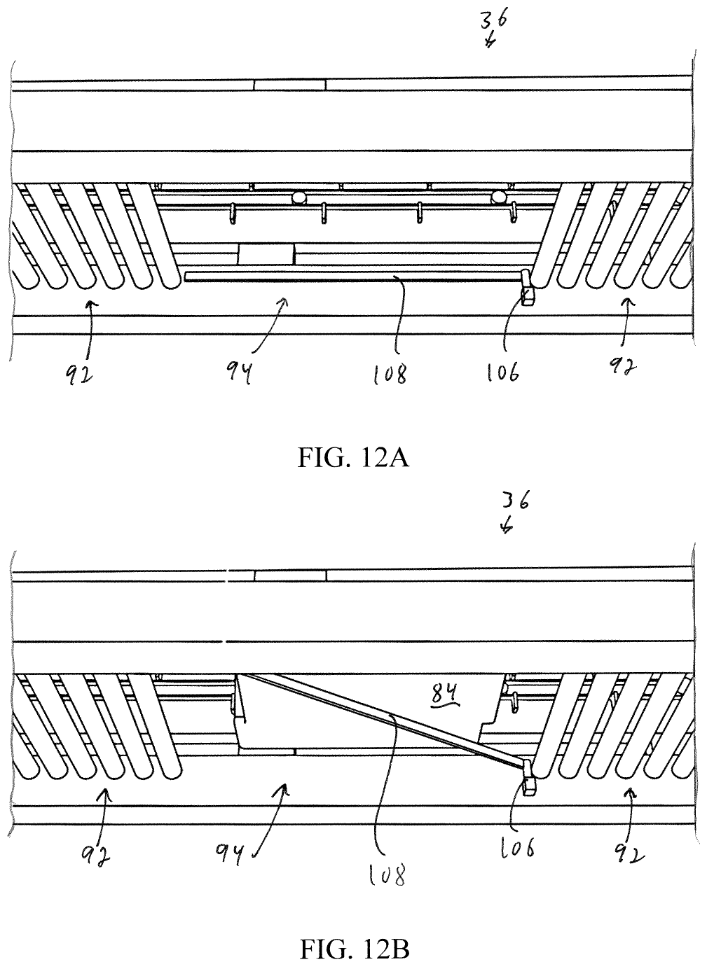

The support structure 52 supports the payload receiving portion 54, which is mounted on a top surface 72 of the support structure 52. The payload receiving portion 54 includes blades 74 on which are mounted narrow bi-directionally actuatable belts 116. FIG. 6A shows end views of the blades 74 with belts 76, and FIG. 6B shows a side view of a blade 74 with a belt 76. The belts 76 may be actuatable by one or more belt drive systems 78 as show in FIG. 12B. The transfer unit 44 is therefore able to move reciprocally (or in two-dimensions as discussed above), and when the blades 74 are elevated, the narrow belts 76 may be actuated in either of two directions to move a payload thereon off of the unit 44.

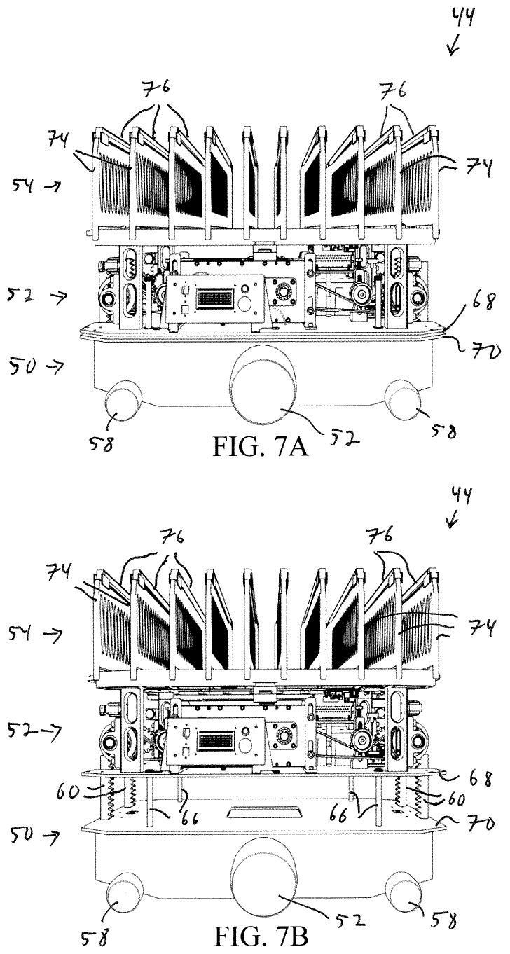

In particular, FIG. 7A shows the support structure 52 and payload receiving portion 54 in a lowered position such that the top surface 70 of the unit base 50 is in contact with the floor 68 of the support structure 52. FIG. 7B shows the support structure 52 and payload receiving portion 54 in an elevated position such that the top surface 70 of the unit base 50 is separated from the floor 68 of the support structure 52 by a distance of a length climbed of the gear racks 60. In accordance with various other aspects of the invention, the elevation of the support structure 92 (and the payload receiving portion 94) with respect to the unit base 90 may be accomplished by a variety of alternative techniques, including for example, screw drives, linear actuators, and mechanical cam systems, etc.

As an alternative to replenishment by the transfer unit, another option is to replenish empty containers by having the shelf be provided as a biasing conveyor. Then, instead of replenishing empty containers via a transfer unit, empty containers are replenished via conveyor (e.g., a destination conveyor). The transfer unit remains, however, to kick full containers out onto a takeaway conveyor. Once a container is kicked out, the containers upstream on the destination conveyor move forward to fill the spot of the now empty position (they accumulate). This opens up a position at the very beginning of the destination conveyor for an empty container to move in. This has the advantage that empty containers need not circulate on a conveyor as they do in other systems and eliminates the need for the transfer unit to service empty containers at all.

Note that during the accumulation step, some or all of the containers may be in motion on the destination conveyor. During this time, the unit sorter must be controlled so as to not deliver to those destination containers known to be in motion (otherwise the sorted object would fall through the conveyor). If the unit sorter has an object for a container in motion, then the unit sorter would re-circulate the object, i.e., send it around the unit sorter again; this has a detrimental effect on the performance of the unit sorter. After accumulation the correspondence between destination codes and positions on the unit sorter is changed, since the physical totes have shifted. A new destination map is provided to the unit sorter.

There are options for accumulation that are determined by the number of zones on the conveyor. One option employs zero-pressure accumulation, in which case there is a zone for each unit sorter position so that none of the containers touch each other. Another option employs minimal-pressure accumulation, in which there is only one conveyor zone resulting in the containers gently touching (such that there is no more than a maximum pressure exerted on each container). There are pros and cons of each. A zero-pressure accumulation conveyor requires a photo-eye or zone at each container location. When the photo-eye is closed, i.e., blocked, the section of destination conveyor under the corresponding container does not advance. So, the photo-eyes keep the containers from touching. container positions are in 1:1 correspondence with conveyor zones. This gives the system controller the ability to control which containers are in motion. If, for instance, the system knows that an object is soon to be sorted into a to-be-accumulated container, the system can wait to accumulate that container until completion of the sort by the unit sorter.

Minimal pressure accumulation, on the other hand, does not a require photo-eye for each unit sorter position. This may reduce expense of the system. However, during accumulation, in the worst case all the remaining containers shift forward. This would prevent the unit sorter from sorting to any of those destinations. Furthermore, in this case the distance between the containers becomes very important. The system is blind to where each container is, it only knows a containers actual position along the conveyor by multiplying the width of the container by the container position. Therefore, if the containers are boxes, for instance, then the boxes widths need to be tightly controlled, or, e.g., put in trays as may be the case with other shuttle sorting systems. To balance these two extremes there are also choices in between where there may be multiple zones, but not as many zones as container positions.

In accordance with further aspects, systems of various aspect of the disclosed and presented systems of the invention may include dynamic destination mapping and scheduling. In particular, for package sortation applications, the destinations on a conventional unit sorter are assigned statically. In any of the automated approaches, due to the fact the destinations no longer have meaning to people pulling from them, the destinations may be assigned dynamically.

For e-commerce applications, where the unit sorter sorts mixed objects into collections of one or more orders, this allows containers with high priority orders, e.g., with expedited fulfillment or shipping, to be kicked out automatically so as to prioritize them as soon as all the objects in the order are received from the unit sorter into the order container.

For package sortation, each destination might be a zip code and/or combination of priority, for instance. In some instances where there are manual takeaway operations, it may be necessary to pull a set of destinations/zip codes at a certain time to make sure the packages are ready for the next truck out for that set of zip codes; there might for example, be a cut time. In any of the automated approaches, the takeaway of the containers to meet these cut times may be performed automatically according to a schedule.

Additionally, for package sortation, dynamic allocation of sort points (at the end of unit sorter chutes) to destinations allows controls and software to modulate the number of chutes assigned to a particular destination in real time and based on a host of reasons. For package sortation more destinations could be added live or up-front if a particular destination/city has a higher-than-normal amount packages to receive during a given sort. Static control algorithms or machine learning-based control algorithms could be employed to assign chutes to destinations based on volume. Dynamic chute allocation also allows re-assignment to occur in real time for redundancy purposes if a particular portion of the machine were to stop; this enables the entire machine to keep running. Dynamic allocation also allows on the fly editing to further break a destination into a sub-group. For example, if Boston, MA is receiving twice the normal packages for a particular sort, the system may assign two destinations instead of one and divide the two new destinations as, for example, north of Boston and south of Boston which alleviates the downstream sorting need.

In the case of dynamic allocation, to ensure accuracy of the entire sortation system, in the cases where the shuttle places, pushes or conveys a container, the container's identity is tracked with a barcode, and the shuttle may have a barcode scanner to scan during place, push or conveyance. This prevents mismatch between virtual state and actual state of containers.

In accordance with further aspects, certain systems of the invention disclosed and described herein may support hybrid takeaway systems. For example, in some of the systems, a container may be deemed to be complete or full by a manual operator, who may manipulate the container, e.g., by pushing the container onto takeaway conveyor in case certain of the systems disclosed and described herein.

The removal and discharging of the containers may also be accomplished in a variety of ways in systems in accordance with various aspects of the present invention. For example, may also involve discharging objects from the containers. This may be particularly important for package sortation applications where the eventual destination for the objects in the container is a plastic bag (or Forever mail bag, e.g.) that may be packed onto an outgoing trailer of the facility. Further, a number of packages in a container could be heavy and hard for a person to tip and dump the container; in this case they may have to transfer packages by hand. In accordance with further aspects, the system disclosed and described herein may take packages or objects in the containers and automatically transfer the objects from the container to a container such as a bag.

One way to achieve this, for example, is to use containers with a hinged bottom. The container is constructed so that its bottom and the packages within fall down while the container walls are supported as discussed further below. Once the packages drop, they can be dropped through directly to a waiting empty bag. Then, a worker removes the now full bag, a label is printed out for the worker to apply to the bag that corresponds to the container's identity. The worker removes the bag and replaces with a new empty bag. Furthermore, the bagging, tagging and removal may all be done automatically. In some applications, not all containers will dump at every dumping station. With the systems described herein dumping can be controlled so that a container can pass the dumping station and dump or not dump. If a container is desired to empty at a particular location, actuated rails retract and allow bottom flap to swing open. If the rails do not retract the container passes the station without dumping.

The labor to process the output (bagging or boxing) is somewhat proportional to the number of bags/boxes used, up to an ergonomic limit. Typically, the less bags/boxes being processed the less labor required. Usually, it behooves the system operator fill bags/boxes as much as possible without exceeding an ergonomic limit. Along these lines typically the largest bag/box which does not result in ergonomic problems results in the lowest cost operation. Under full bags/boxes results in shipping air from the sorting site which is costly. So, once a container under the sorter is considered full, a bag/box process that can right size the bag/box to just hold the contents of the container is the most economical option. The proposed system may monitor the actual contents of and output container for the objects, and may advise a manual or robotic bagging/boxing operation that is the right size outbound bag/box. If the sorter of which the automated take away and bagging/boxing is being done in connection with is for sorting sealed packages being shipped from A to B; then more optimizations can be applied. The output of a package sorter used in a logistics operation often must meet truck times or plane times. An automated take away system can automatically discharge destinations from the sorter to meet their truck time or plane time.

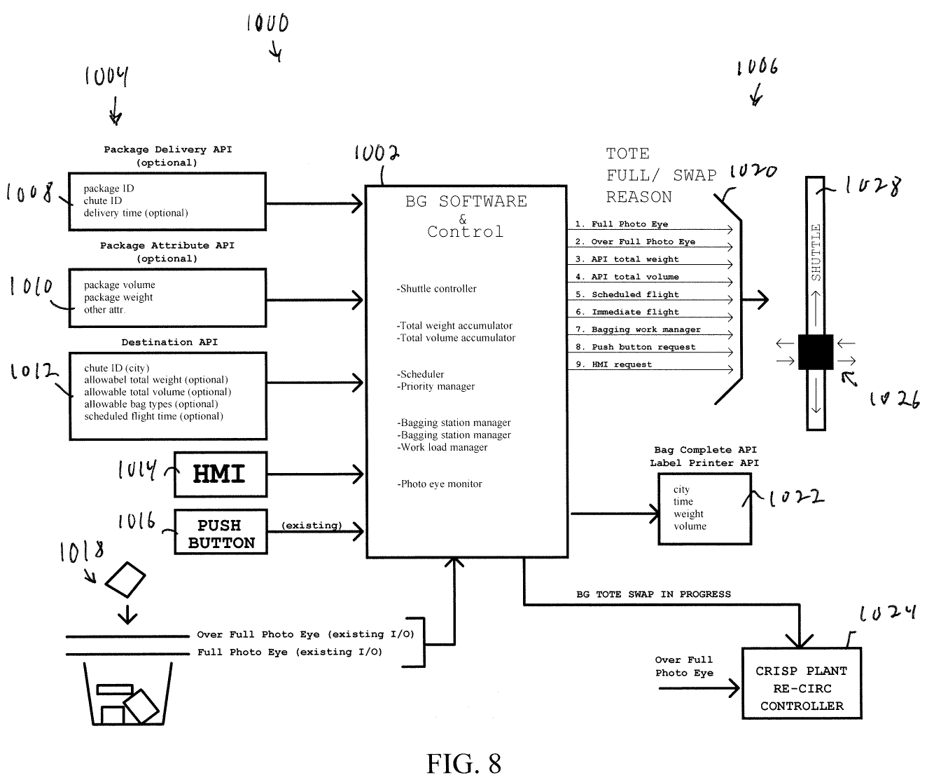

FIG. 8 for example, shows a functional diagram of a container and bag fullness analysis system 1000 for use in accordance with an aspect of the invention (e.g., in any of the object processing systems discussed herein). The analysis system 1000 determines when a container is complete enough to be traded for an empty container, and includes a software and control system 1002 (e.g., that may reside in the one or more computer processing systems 100, 200). The system 1000 receives input parameters as shown at 1004 and provides completeness determinations as shown at 1006 based on any of a variety of reasons as discussed below. The input parameters include package delivery information shown at 1008, package attribute information shown at 1010, destination information shown at 1012, human machine interface information shown at 1014, push button information shown at 1016, and full and over-full detection information as shown at 1018.

The package (object) delivery information (e.g., provided via an application programming interface, API), includes package ID, chute ID and delivery time as shown at 1008. The package attribute information (e.g., provided via API) includes package volume, package weight, package size and other attributes as shown at 1010. The destination information (e.g., provided via API) includes chute ID (city, allowable total weight, allowable total volume, allowable bag types, and scheduled leaving times (e.g., flight times). The human machine interface may provide additional observable information regarding the package as shown at 1014, and the push button information may include pre-programmed select information that may be entered very quickly as shown at 1016. The full and over-full detection information as shown at 1018 may be provided by one or more sensor systems discussed above with reference to the detector pairs 27, 29 of FIGS. 6A and 6B.

The software and control system 1002 receives the above input information and processes the data to control the transfer unit, monitor total weight accumulated, monitor total volume accumulated, monitor any changes in the schedule and/or priority, and monitor the full and over-full detection information. The control system 1002 also communicates with boxing and bagging station managers as well as work-load managers. The system, for example, may not simply rely on one or two points of information (e.g., a full or over-full sensor signal), but may consider total weight or total volume. If the total weight and/or total volume are far too low, the system will not consider the container to be completed. On the other hand, if a scheduled leaving time (e.g., flight) or immediate leaving time is approaching, the system may consider the container to be completed not-withstanding other data indicating otherwise. Further, the system may be immediately responsive to instructions from a boxing or bagging station manager, a push button request, and/or a human machine interface instruction to immediately consider the container to be completed. When the control system 1002 considers a container to be completed, a bag-complete label is printed as shown at 1022, and a new empty container is requested in a container swap as shown at 1024. The detector pairs on the new empty container may be checked to ensure that the container is empty. The completed container is then discharged as shown at 1026 onto a shuttle or conveyor 1028 (e.g., a bin holding conveyor 32 as shown in FIG. 1). Once a bin is determined to be ready to be discharged (completed), the system moves the completed bin onto the replenishment and takeaway conveyor as discussed above.

The containers 20 of the systems discussed above with reference to FIGS. 1-5B may be specifically adapted to transfer any contents therein during movement (as noted above). FIG. 9 shows a container 20 that includes a container body 80 that includes an upper rim 82. The container 20 also includes a bottom 84 that is attached to the body 80 via hinge assemblies 86, we well as engagement features 88.

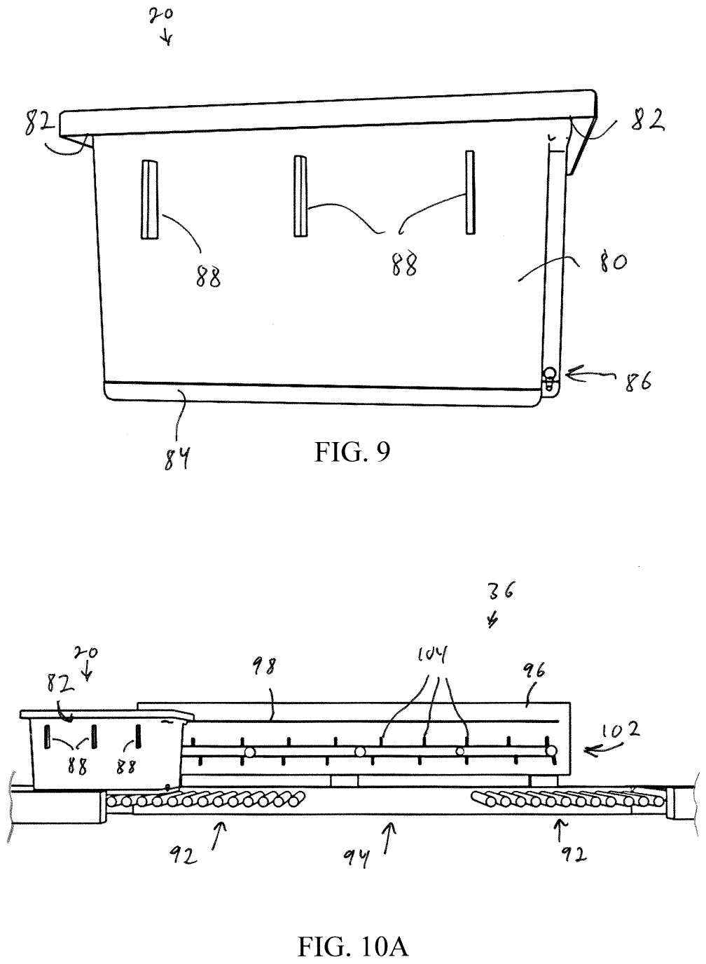

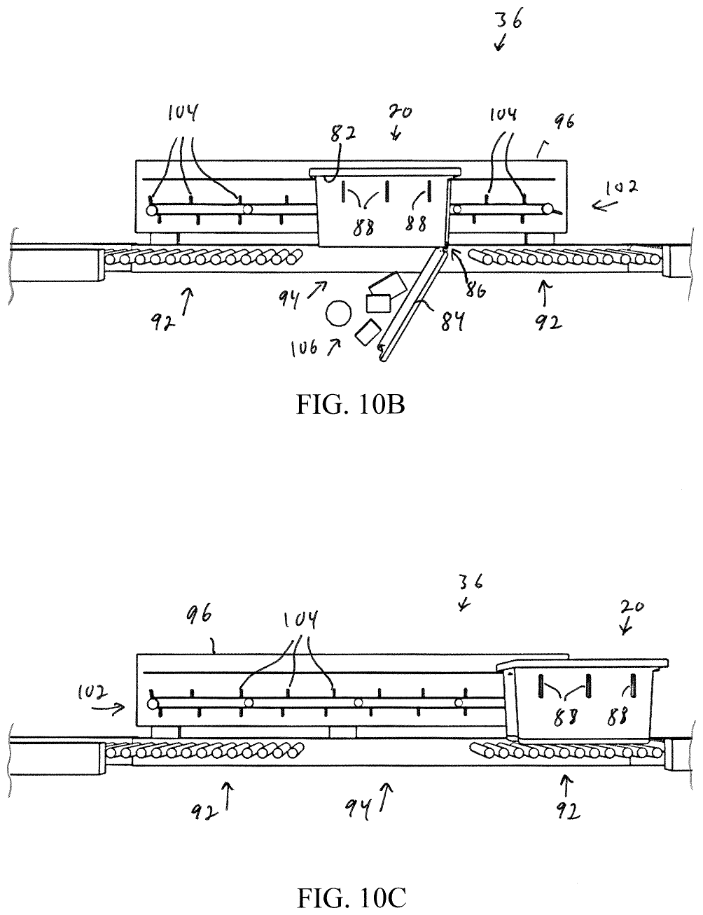

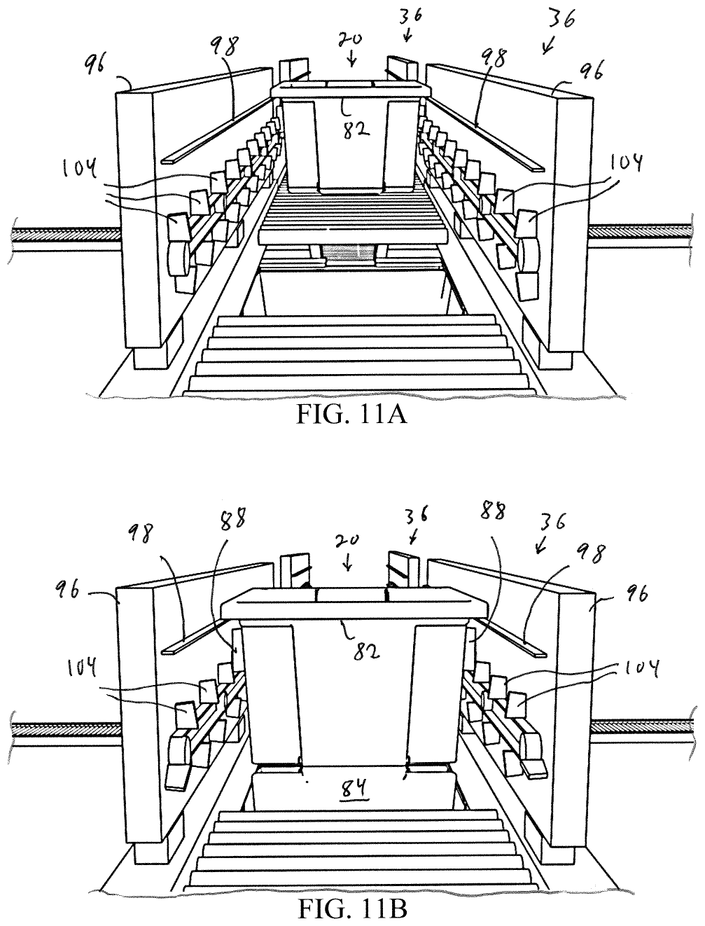

With further reference to FIG. 10A, each container emptying station 36 may include a discharge conveyor section 90 that includes rollers 92 on either side of an opening as shown at 94. A portion of the station 36 is removed for clarity in FIGS. 10A-10C. The container emptying station 36 also includes a pair of opposing walls 96 (both of which are shown in FIGS. 11A and 11B), and each wall 96 includes a ridge 98 on which the upper rim 82 of each container 20 may rest when in the container emptying station 36. Each wall 96 also includes a drive system 102 (e.g., chain or belt drive) that includes paddles 104. The upper portion of the belt or chain travels along the conveyor section, and the paddles 104 engage the engagement features 88 of each container 20.

With further reference to FIG. 10B, when the container 20 is positioned above the opening 94 in the rollers (and in particular then the bottom 84 disengages with the last roller adjacent the opening, the bottom 84 swings open dumping any contents therein 106 into a box or bag positioned below the conveyor section. With reference to FIG. 10C, as the container 20 is further moved along the conveyor direction by the drive system 102, the bottom 84 engages the leading roller adjacent the opening 94 and is urged closed, returning to the body 80. This later part of the conveyor section is powered to continue to move the (now empty) container through the system. FIG. 11A shows the container 20 with the upper rim 82 engaging the ridges 98 of each wall 96, and FIG. 11B shows the paddles 104 of the drive system 102 engaging the paddles 88 of the container 20 drawing the container 20 over the opening 94.

With reference again to FIGS. 1 and 2, the system may include plural serial container emptying stations 36, and each station 36 may further include an override mechanism to prevent the contents of a container to be discharged any non-selected stations. For example, FIG. 12A shows an underside view of a station 36 that includes an override motor 106 that is able to selectively rotate an override bar 108 over the opening 94. With reference to FIG. 12B, when the override bar 108 is rotated over the opening 94, the container 20 is still pulled along by the drive system 102 but the bottom 84 does not open. In this way, each container may be opened only at a selected station.

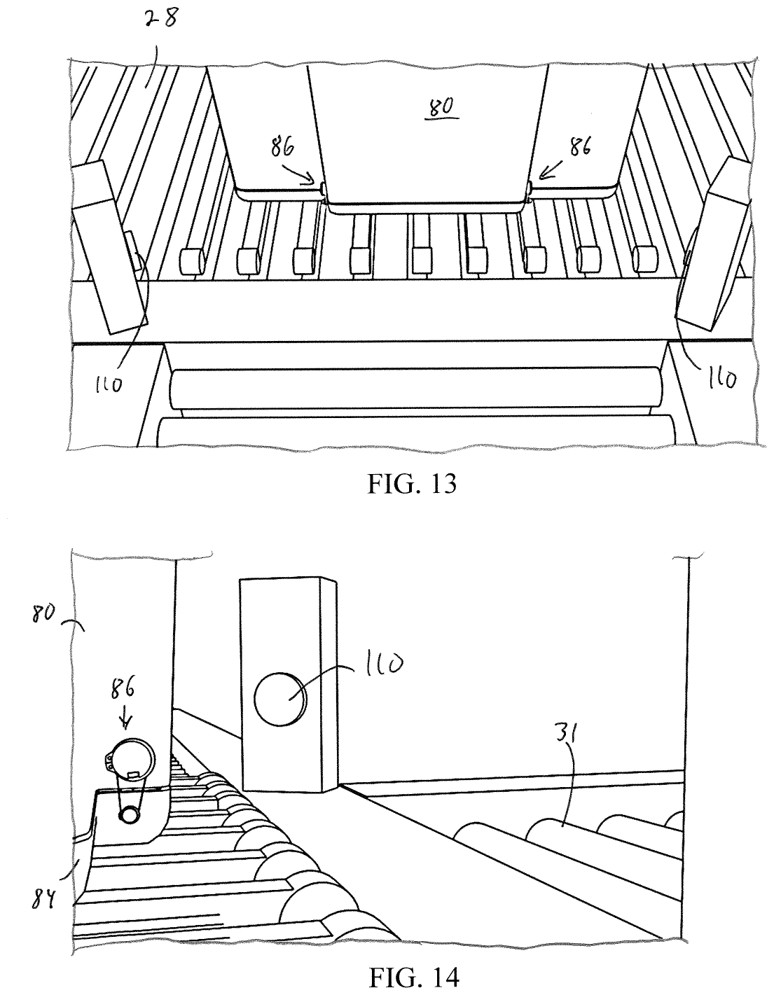

The system may also include check systems to ensure that any containers are properly oriented in the system, for example, to prevent jams if a bottom opened facing the wrong direction. For example and with reference to FIG. 13, the system may include perception systems 110 at the entrance conveyor 31 to the container emptying stations 36. The entrance conveyor 31 may have an associated bi-directional diverter 33 on the conveyor 28 that directs the container toward the entrance conveyor 31. With further reference to FIG. 14 the perception systems 110 (together with the one or more computer processing systems) will look for the hinge assemblies 86 (or a specialized material thereon such as reflectors) to ensure that the hinge side of the container is entering first. If not, the container may be routed to an exit 42.

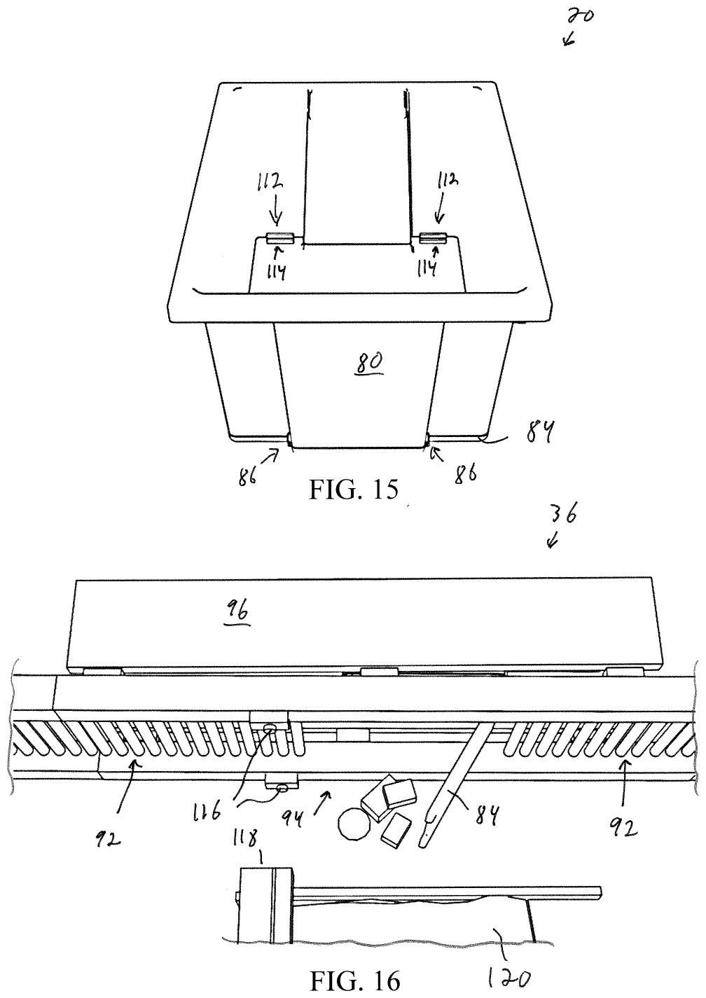

Additionally, each container 20 may include a closed-detection system that may, for example, include proximity elements 112, 114 as shown in FIG. 15 that detect when the bottom is closed. This may facilitate confirming (together with the one or more computer processing systems 100) that contents have been discharged as intended, and will further signal whether a container is lifted (e.g., by human personnel) within the system (which is not intended). The closed-detection system may further include small magnetic force magnets to facilitate aligning the bottom with the body when closing, yet not provide sufficient force to inhibit the bottom from dropping due to its own weight.

In accordance with further aspects and with reference to FIG. 16, each of the container emptying stations 36 may further include perception systems 116 on the underside thereof that may be used (together with the one or more computer processing systems 100) to confirm that a destination location includes a movable bag hanger 118 with an associated bag 120. The bag hangers may be provided on rollers (as shown in FIG. 2), and ensuring that the hanger and bag assemblies are properly positioned below any active container emptying stations 36 may facilitate preventing delays of a variety of natures.

Those skilled in the art will appreciate that numerous modifications and variations may be made to the above disclosed embodiments without departing from the spirit and scope of the present invention.

What is claimed is:

1. An object processing system comprising:
a distribution system for distributing a plurality of objects among a plurality of containers;
an output conveyance system for receiving a plurality of completed containers; and
a container discharge system for emptying any contents of a container of the plurality of completed containers into a destination location, the container discharge system including a discharge conveyor section in which the container is suspended and moved in a conveyor direction while permitting a bottom of the container to drop open to discharge any contents of the container into the destination location.

2. The object processing system as claimed in claim 1, wherein each of the plurality of completed containers includes a bottom that may be opened.

3. The object processing system as claimed in claim 1, wherein each of the plurality of completed containers includes a bottom that freely opens by gravity.

4. The object processing system as claimed in claim 3, wherein the bottom of each of the plurality of completed containers is coupled to a body portion of each of the plurality of completed container by a hinged coupling.

5. The object processing system as claimed in claim 1, wherein the discharge conveyor section is a roller conveyor without selected rollers of the roller conveyor.

6. The object processing system as claimed in claim 1, wherein the container discharge system includes at least one drive belt or chain for moving the container in the conveyor direction.

7. The object processing system as claimed in claim 6, wherein the at least one drive belt or chain includes paddles attached thereto.

8. The object processing system as claimed in claim 6, wherein the container includes engagement features for engaging the paddles of the drive belt or chain.

9. The object processing system as claimed in claim 1, wherein the destination location includes a bag for receiving the contents of the container.

10. The object processing system as claimed in claim 1, wherein the container discharge system includes an override mechanism to selectively prevent the bottom of the container from opening.

11. An object processing system comprising:
a distribution system for distributing a plurality of objects among a plurality of containers;
an output conveyance system for receiving a plurality of completed containers, each of said completed containers being provided on the output conveyance system but not being fixedly attached to the output conveyance system; and
a container discharge system for emptying any contents of a container of the plurality of completed containers into a destination location, the container discharge system including a discharge conveyor section in which the container may drop open to discharge any contents of the container into the destination location.

12. The object processing system as claimed in claim 11, wherein each of the plurality of completed containers includes a bottom that may be opened.

13. The object processing system as claimed in claim 11, wherein each of the plurality of completed containers includes a bottom that freely opens by gravity.

14. The object processing system as claimed in claim 13, wherein the bottom of each of the plurality of completed containers is coupled to a body portion of each of the plurality of completed container by a hinged coupling.

15. The object processing system as claimed in claim 11, wherein the discharge conveyor section is a roller conveyor without selected rollers of the roller conveyor.

16. The object processing system as claimed in claim 11, wherein the container discharge system includes at least one drive belt or chain for moving the container in the conveyor direction.

17. The object processing system as claimed in claim 16, wherein the at least one drive belt or chain includes paddles attached thereto.

18. The object processing system as claimed in claim 16, wherein the container includes engagement features for engaging the paddles of the drive belt or chain.

19. The object processing system as claimed in claim 11, wherein the destination location includes a bag for receiving the contents of the container.

20. The object processing system as claimed in claim 11, wherein the container discharge system includes an override mechanism to selectively prevent the bottom of the container from opening.

21. A method of processing objects comprising:
receiving a plurality of completed containers; and
emptying any contents of a container of the plurality of completed containers into a destination location by moving the container along a discharge conveyor section in which the container is suspended and moved in a conveyor direction while permitting a bottom of the container to drop open to discharge any contents of the container into the destination location.

22. The method of claim 21, wherein each of the plurality of completed containers includes a bottom that freely opens by gravity.

23. The method of claim 22, wherein the bottom of each of the plurality of completed containers is coupled to a body portion of each of the plurality of completed container by a hinged coupling.

24. The method of claim 21, wherein the discharge conveyor section is a roller conveyor without selected rollers of the roller conveyor.

25. The method of claim 21, wherein the container discharge system includes at least one drive belt or chain for moving the container in the conveyor direction.

26. The method of claim 25, wherein the at least one drive belt or chain includes paddles attached thereto.

27. The method of claim 25, wherein the container includes engagement features for engaging the paddles of the drive belt or chain.

28. The method of claim 21, wherein the method further includes actuating an override mechanism to selectively prevent the bottom of the container from opening.

29. A container for use in an object processing system comprising a body with an open top and a bottom that is movably attached to the body such that the bottom may open away from the body when not supported from below the bottom.

30. The container as claimed in claim 29, wherein the container further includes suspension features for suspending the container when the bottom is not supported.

31. The container as claimed in claim 29, wherein the container further includes engagement features for engagement by a translation system for moving the container when the bottom is not supported.
